(19) United States
(12) Patent Application Publication
(10) Pub. No.: US 2009/0046678 A1
(43) Pub. Date: Feb. 19, 2009

(54) Method for predicting the mobility in mobile ad hoc networks

(75) Inventors: Young-Koo Lee, Yongin-si (KR); Sungyoung Lee, Seongnam-si (KR); Hui Xu, Yongin-si (KR)

Correspondence Address: ROTHWELL, FIGG, ERNST & MANBECK, P.C., 1425 K STREET, N.W., SUITE 800, WASHINGTON, DC, 20005, US

(73) Assignee: Industry-Academic Cooperation Foundation of Kyung Hee University, Yongin-si (KR)

(21) Appl. No.: 11/892,031

(22) Filed: Aug. 17, 2007

(51) Int. Cl. H04Q 7/24

(52) U.S. Cl. 370/338

(57) ABSTRACT

Disclosed are methods for determining the neighborhood local view of a mobile node in time which can facilitate the forwarding decision in the design of network protocols. In conventional mobile ad hoc networks nodes set up local topology view based on periodical received “Hello” messages. The conventional method is replaced with proactive and adaptive methods of predicting locations of nodes based on preserved historical information extracted from received “Hello” messages and constructing neighborhood view by aggregating predicted locations. This method is useful for providing updated and consistent topology local view that a network communication employs to determine optimal forward decisions and improve communication performance.

### BACKGROUND

1. Technical Field

The invention relates generally to the communication of wireless LANs and more specifically to communication of mobile ad hoc networks. Still more specifically, the invention relates to methods of predicting the mobility of mobile devices for constructing precise neighborhood local view in such networks.

2. Description of the Related Art

In most existing localized protocols for Mobile Ad hoc Networks (MANETs), each node emits “Hello” messages to advertise its presence and update its information. In periodical update, “Hello” intervals at different nodes can be asynchronous to reduce message collision. Each node extracts its neighbors' information from latest received “Hello” messages to construct a local view of its neighborhood (e.g., 1-hop location information).

However, there are two main problems in that kind of neighborhood local view construction scheme. 1) Outdated local view: when we consider a general case where broadcasts or routing occur within “Hello” message interval while nodes move during that interval, forward decisions of localized protocols will be based on outdated neighborhood view; 2) Asynchronous local view: asynchronous sample frequency at each node, asynchronous “Hello” intervals in periodical update, and different “Hello” intervals in conditional update will cause asynchronous information for each neighbor in neighborhood local view.

Forward decisions based on outdated and asynchronous network topology view may be inaccurate and hence cause delivery failure which can induce poor coverage of broadcast task or route failures. If the dynamics of the network topology could be predicted in advance, appropriate forward decision can be made in order to avoid or reduce delivery failures. Neighborhood tracking is a task to determine the neighborhood local view of a mobile node in time which can facilitate the forwarding decision in network protocols' design. Therefore, it could be of significance to the design of network protocols.

There exist two kinds of work which try to maintain accurate topology view to assist the route path selection. First, in the work of Kim et al. (W.-I. Kim, D. H. Kwon, and Y.-J. Suh, “A reliable route selection algorithm using local positioning systems in mobile ad hoc networks,” In Proceedings the IEEE International Conference on Communications, Amsterdam, USA, pp. 3191-3195, June, 2001.), a stable zone and a caution zone of each node have been defined based on a node's position, speed, and direction information obtained from GPS. Specifically, a stable zone is the area in which a mobile node can maintain a relatively stable link with its neighbor nodes since they are located close to each other. A caution zone is the area in which a node can maintain an unstable link with its neighbor nodes since they are relatively far from each other. Second, Wu and Dai (J. Wu and F. Dai, “Mobility Control and Its Applications in Mobile Ad Hoc Networks,” Accepted to appear in Handbook of Algorithms for Wireless Networking and Mobile Computing, A. Boukerche (ed.), Chapman & Hall/CRC, pp. 22-501-22-518, 2006.) have proposed a conservative “two transmission radius” method to compensate the outdated topology local view. However, all the above approaches are passive since they just try to compensate the inaccuracy of network topology view rather than predict mobile nodes' positions to construct precise network topology view in advance.

### SUMMARY

The present invention achieves the foregoing features and results, as well as others, by providing methods to predict the neighborhood of mobile nodes in time in wireless ad hoc networks.

To address asynchronism problem, the present invention attaches the current sending time into “Hello” messages. Nodes which receive “Hello” messages should include not only message contents but also reception time. By comparing reception time and sending time in “Hello” message, the time difference between two nodes can be calculated. To get a synchronized local view of any node S at any future time t, the present invention sets node S as the reference node and deduce its neighbor's synchronous time t′. To construct the updated neighborhood local view, piecewise linear and nonlinear prediction models are proposed which make use of a node's latest two or one information to predict its future location. By aggregating predicted neighbors' location, node S can construct the updated and synchronous neighborhood view at actual transmission time.

Using the methods of the invention, a dynamic approach can be made use of to construct predictive synchronized neighborhood local view when a routing or broadcasting task is triggered. Then the existing localized protocols can make forward decisions based on this updated local view which can improve the performance of protocols.

### BRIEF DESCRIPTION OF THE DRAWINGS

FIG. 1 is a flowchart showing a method for predicting the mobility in mobile ad hoc networks according to a embodiment consistent with the present invention.

FIG. 2 is a analysis model for prediction interval according to a embodiment consistent with the present invention.

FIG. 3A is the sketch of location-based prediction model according to a embodiment consistent with the present invention.

FIG. 3B is the sketch of velocity-aided prediction model according to a embodiment consistent with the present invention.

FIG. 3C is the sketch of constant acceleration prediction model according to a embodiment consistent with the present invention.

FIG. 4 is the function of smaller neighborhood range according to a embodiment consistent with the present invention.

FIG. 5 is analysis model for smaller neighborhood range according to a embodiment consistent with the present invention.

FIGS. 6A and 6B show examples of neighborhood tracking in periodical update where the Z dimension coordinates according to a embodiment consistent with the present invention.

### DETAILED DESCRIPTION

### 1. Predictive and Synchronized Neighborhood Tracking Overview

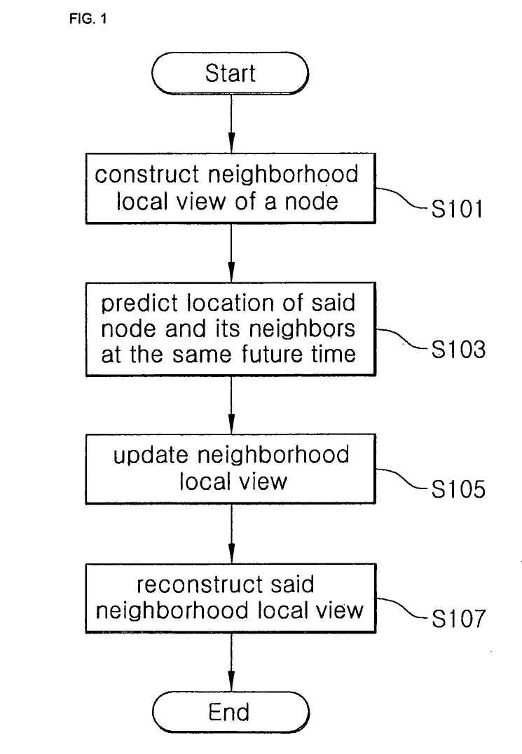

Neighborhood tracking method flowchart of the present invention is shown in FIG. 1. In FIG. 1, method for predicting the mobility in mobile ad hoc networks is illustrated. First step is constructing neighborhood local view (S101). Next step is predicting locations of said node and its neighbor nodes at the same future time using said neighborhood local view (S103). Next step is updating neighborhood local view by aggregating neighbors' predicted location (S105). And next step is reconstructing said neighborhood local view by setting smaller neighborhood range (S107).

In FIG. 1, to address the asynchronous and outdated local view problem, the location of node S and the location of all its neighbor nodes are predicted at the same future time tₚ (with node S's clock) which is the node S's actual emission time t_{b}+broadcast delay time t_{D}. By collecting the predicted locations, node S can construct an updated and synchronized neighborhood local view. The delay time t_{D} includes not only the wireless network transmission delay tₑ but also the packet and transmission processing time tₛ. tₑ is basically fixed in wireless networks while tₛ can vary according to packet size.

Moreover, the prediction interval is also affected by some other factors and has a bound which we will analyze in next separate section. However there are still two issues: how to calculate neighbor nodes' corresponding prediction time and how to predict nodes' locations.

To calculate any neighbor node A's prediction time t′ₚ, its time difference to reference node S, t′_{d} is calculated. Then t′ₚ=tₚ+t′_{d}. To get t′_{d}, local sending time t₁ and local received time tᵣ are included in “hello” messages. Then the time difference between two nodes can be calculated as t′_{d}=tₗ−tᵣ+tₑ where tₑ is the wireless network transmission delay.

### 2. Analysis for Prediction Interval

When we schedule an actual transmission time for node S, if within the prediction interval, neighbor nodes already move out of the transmission range of node S, our prediction scheme will have no meaning. Therefore we analyze the Transmission Range Dwell Time, T_{dwell}, the time period within which any neighbor node U stays in the transmission range of node S. R_{dwell} is the rate of crossing the boundary of its transmission range.

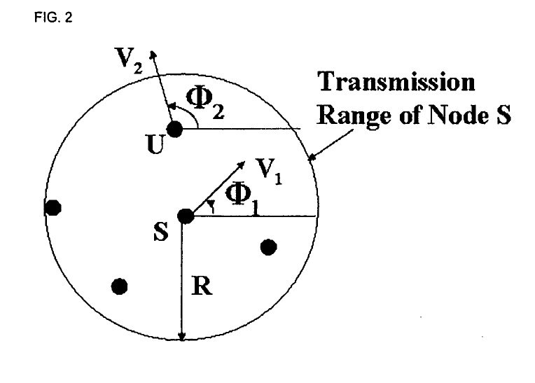

FIG. 2 shows an analytical model where we assume that node S moves with a velocity \vec{V}₁ and node U moves with a velocity \vec{V}₂. The relative velocity \vec{V} of node U to node S is given by

\vec{V}=\vec{V}₂−\vec{V}₁ (1)

The magnitude of \vec{V} is given by

V=\sqrt{V₁²+V₂²−2V₁V₂ cos(Φ₁−Φ₂)} (2)

where V₁ and V₂ are the magnitudes of \vec{V}₁ and \vec{V}₂, respectively. The mean value of V is given by

$$E [ V ] = {\int }_{{V}_{min}}^{{V}_{max}} {\int }_{{V}_{min}}^{{V}_{max}} {\int }_{0}^{2 π} {\int }_{0}^{2 π} \sqrt{{u}_{1}^{2} + {u}_{2}^{2} - 2 {u}_{1} {u}_{2} cos ( {φ}_{1} - {φ}_{2} )} {fv}_{1} , {v}_{2} , {Φ}_{1} , {Φ}_{2} ( {u}_{1} , {u}_{2} , {φ}_{1} , {φ}_{2} ) d {φ}_{1} d {φ}_{2} d {u}_{1} d {u}_{2} \qquad ( 3 )$$

where f_{V}_{₁}_{,V}_{₂}_{Φ}_{₁}_{,Φ}_{₂}(v₁,v₂,φ₁,φ₂) is the joint pdf of the random variables V₁, V₂, Φ₁, Φ₂, Vₘᵢₙ and Vₘₐₓ are the minimum and maximum moving speeds, the symbol E[V] is an average value of the random variable V. Since the moving speeds V₁ and V₂ and directions Φ₁ and Φ₂ of nodes S and U are independent, Eq. (3) can be simplified

$$E [ V ] = {\int }_{{V}_{min}}^{{V}_{max}} {\int }_{{V}_{min}}^{{V}_{max}} {\int }_{0}^{2 π} {\int }_{0}^{2 π} \sqrt{{υ}_{1}^{2} + {υ}_{2}^{2} - 2 {υ}_{1} {υ}_{2} cos ( {φ}_{1} - {φ}_{2} )} {f}_{V} ( {υ}_{1} ) {f}_{V} ( {υ}_{2} ) {f}_{Φ} ( {φ}_{1} ) {f}_{Φ} ( {φ}_{2} ) d {φ}_{1} d {φ}_{2} d {υ}_{1} d {υ}_{2} \qquad ( 4 )$$

If Φ₁ and Φ₂ are uniformly distributed in (0, 2π), Eq. (4) can be further rewritten as

$$E [ V ] = \frac{1}{{π}^{2}} {\int }_{{V}_{min}}^{{V}_{max}} {\int }_{{V}_{min}}^{{V}_{max}} ( {υ}_{1} + {υ}_{2} ) {F}_{e} ( \frac{2 \sqrt{{υ}_{1} {υ}_{2}}}{{υ}_{1} + {υ}_{2}} ) {f}_{V} ( {υ}_{1} ) {f}_{V} ( {υ}_{2} ) d {υ}_{1} d {υ}_{2} \qquad ( 5 )$$

where

$${F}_{ɛ} ( k ) = {\int }_{0}^{1} \sqrt{\frac{1 - {k}^{2} {t}^{2}}{1 - {t}^{2}}} d t$$

is complete elliptic integral of the second kind. Therefore, now we can consider that node S is stationary, and node U is moving at a relative velocity.

Assume that nodes are distributed uniformly and nodes' moving direction is distributed uniformly over [0, 2π], the mean value of R_{dwell} is given by

$${R}_{dwell} = \frac{E [ V ] L}{π A} \qquad ( 6 )$$

where A is the area of the transmission range and L is the perimeter of this area. Therefore

$$E [ {T}_{dwell} ] = \frac{π A}{E [ V ] L} \qquad ( 7 )$$

In a word, our prediction interval should be bounded within the time E[T_{dwell}].

### 3. Mobility Prediction

Camp et al. (T. Camp, J. Boleng and V. Davies, “A Survey of Mobility Models for Ad Hoc Network Research,” Wireless Comm. & Mobile Computing (WCMC), special issue on mobile ad hoc networking: research, trends and applications, vol. 2, no. 5, pp. 483-502, 2002.) have given a comprehensive survey on mobility models for MANETs, from which we can find that in some models nodes move linearly before changing direction. In the other models, they are not precisely linearly movement, nodes also move linearly in a segment view.

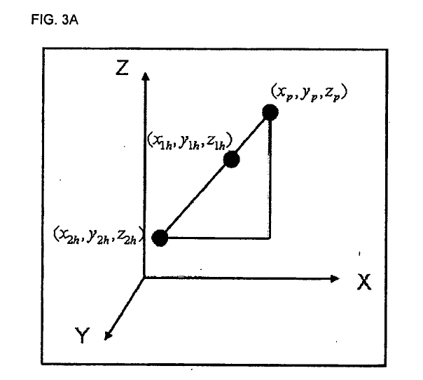

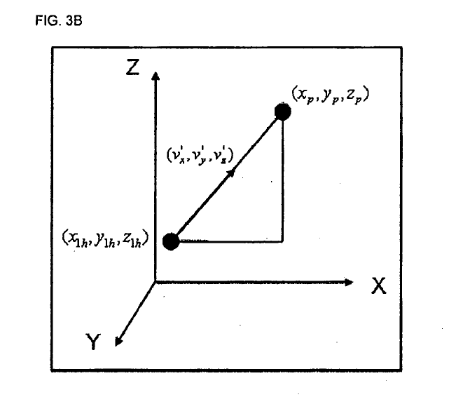

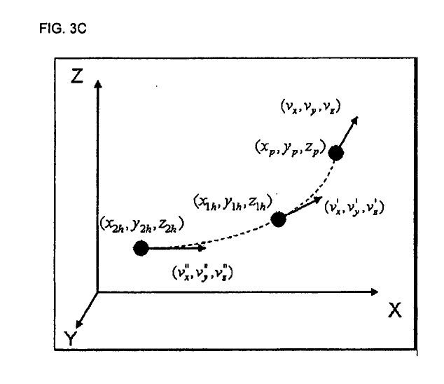

Location-based Prediction: Suppose that there are two latest updates for a particular node respectively at time t₁ₕ and t₂ₕ (t₁ₕ>t₂ₕ) with location information of (x₁ₕ, y₁ₕ, z₁ₕ) and (x₂ₕ, y₂ₕ, z₂ₕ). Assume at least within two successive update periods the node moves in a straight line with fixed speed as depicted in FIG. 3A, we obtain

$$\{ \begin{matrix}\frac{{x}_{1 h} - {x}_{2 h}}{{t}_{1 h} - {t}_{2 h}} = \frac{{x}_{p} - {x}_{1 h}}{{t}_{p} - {t}_{1 h}} \\ \frac{{y}_{1 h} - {y}_{2 h}}{{t}_{1 h} - {t}_{2 h}} = \frac{{y}_{p} - {y}_{1 h}}{{t}_{p} - {t}_{1 h}} \\ \frac{{z}_{1 h} - {z}_{2 h}}{{t}_{1 h} - {t}_{2 h}} = \frac{{z}_{p} - {z}_{1 h}}{{t}_{p} - {t}_{1 h}}\end{matrix} \qquad ( 8 )$$

then the location (xₚ, yₚ, zₚ) at a future time tₚ can be calculated as

$$\{ \begin{matrix}{x}_{p} = {x}_{1 h} + \frac{{x}_{1 h} - {x}_{2 h}}{{t}_{1 h} - {t}_{2 h}} ( {t}_{p} - {t}_{1 h} ) \\ {y}_{p} = {y}_{1 h} + \frac{{y}_{1 h} - {y}_{2 h}}{{t}_{1 h} - {t}_{2 h}} ( {t}_{p} - {t}_{1 h} ) \\ {z}_{p} = {z}_{1 h} + \frac{{z}_{1 h} - {z}_{2 h}}{{t}_{1 h} - {t}_{2 h}} ( {t}_{p} - {t}_{1 h} ) .\end{matrix} \qquad ( 9 )$$

In the conditional update, however, this model cannot be used because the latest update represents considerable changes compared to previous update.

Velocity-aided Prediction: Let (v′ₓ, v′_{y}, v′_{z}) be the velocity of its latest update for a particular node. Assume the node moves with the speed within update period as depicted in FIG. 3B, the location (xₚ, yₚ, zₚ) at a future time tₚ can be calculated as

$$\{ \begin{matrix}{x}_{p} = {x}_{1 h} + {υ}_{x}^{′} ( {t}_{p} - {t}_{1 h} ) \\ {y}_{p} = {y}_{1 h} + {υ}_{y}^{′} ( {t}_{p} - {t}_{1 h} ) \\ {z}_{p} = {z}_{1 h} + {υ}_{z}^{′} ( {t}_{p} - {t}_{1 h} ) .\end{matrix} \qquad ( 10 )$$

In high speed mobility networks we can assume the force on the moving node is constant, that is, nodes move with constant acceleration.

Constant Acceleration Prediction: Let (v′ₓ, v′_{y}, v′_{z}) and (″ₓ, v″_{y}, v″_{z}) respectively be the velocity of those two update as depicted in FIG. 3C. The principle of motion law are

V=v+at (11)

and

$$S = υ t + \frac{1}{2} {at}^{2} = \overline{υ} t = \frac{υ + V}{2} t \qquad ( 12 )$$

where S is the displacement, v is the initial velocity and a is the acceleration during period t. We employ V denoting the final velocity after period t.

Assume the fixed acceleration (aₓ, a_{y}, a_{z}), and we apply above principle to X-dimension, we can obtain

$$\{ \begin{matrix}{υ}_{x}^{′} = {υ}_{x}^{″} + {a}_{x} ( {t}_{1 h} - {t}_{2 h} ) \\ {υ}_{x} = {υ}_{x}^{′} + {a}_{x} ( {t}_{p} - {t}_{1 h} ) \\ {x}_{p} - {x}_{1 h} = \frac{( {υ}_{x}^{′} + {υ}_{x} )}{2} ( {t}_{p} - {t}_{1 h} )\end{matrix} \qquad ( 13 )$$

Then we can get the expected location xₚ as:

$${x}_{p} = {x}_{1 h} + \frac{2 {υ}_{x}^{′} + ( {υ}_{x}^{′} - {υ}_{x}^{″} ) \frac{{t}_{p} - {t}_{1 h}}{{t}_{1 h} - {t}_{2 h}}}{2} ( {t}_{p} - {t}_{1 h} ) \qquad ( 14 )$$

Since Y and Z dimensions are the same with X-dimension, we obtain

$$\{ \begin{matrix}{x}_{p} = {x}_{1 h} + \frac{2 {υ}_{x}^{′} + ( {υ}_{x}^{′} - {υ}_{x}^{″} ) \frac{{t}_{p} - {t}_{1 h}}{{t}_{1 h} - {t}_{2 h}}}{2} ( {t}_{p} - {t}_{1 h} ) \\ {y}_{p} = {y}_{1 h} + \frac{2 {υ}_{y}^{′} + ( {υ}_{y}^{′} - {υ}_{y}^{″} ) \frac{{t}_{p} - {t}_{1 h}}{{t}_{1 h} - {t}_{2 h}}}{2} ( {t}_{p} - {t}_{1 h} ) \\ {z}_{p} = {z}_{1 h} + \frac{2 {υ}_{z}^{′} + ( {υ}_{z}^{′} - {υ}_{z}^{″} ) \frac{{t}_{p} - {t}_{1 h}}{{t}_{1 h} - {t}_{2 h}}}{2} ( {t}_{p} - {t}_{1 h} ) .\end{matrix} \qquad ( 15 )$$

Finally, by collecting predicted locations, we can construct an updated and consistent neighborhood local view.

### 4. Enhancement Scheme

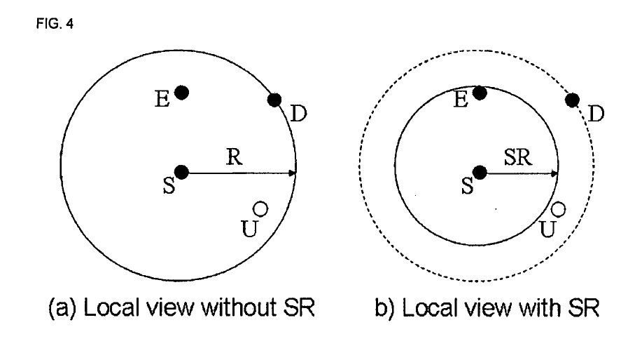

Inaccurate Local View: Although we provide a predictive and synchronized solution, however there exists another possible situation which can cause inaccurate local view. That is, a node S has not received a node U's latest update, so S neglects the existence of U. However U moves into the node S's neighborhood during prediction time. FIG. 4(a) shows the predicted local view of node S, where node U is not included although it is the neighbor of S.

Smaller Neighborhood Range Scheme: In order to prevent the afore mentioned problem, we propose how to reconstruct the neighborhood local view of S by applying smaller neighborhood radius (SR). By applying SR scheme, node S achieves smaller but accurate local view which is shown in FIG. 4(b).

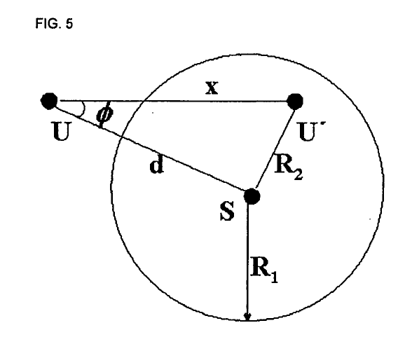

Consider two nodes S and U as shown in FIG. 5. Node U is not within the transmission range of node S at time t₀ and moves to position U′ at t₁. Assume that their distance at t₀ is d and U moves a distance of x with respect to S at t₁. The probability that U enters into the transmission range of S is

$$p ( x , d ) = \{ \begin{matrix}0 \text{:} & x < d - {R}_{1} \\ \frac{φ}{π} \text{:} & d - {R}_{1} \leq x \leq d + {R}_{1} \\ 0 \text{:} & x > d + {R}_{1} ,\end{matrix} \qquad ( 16 )$$

where

$$φ = arccos ( \frac{{x}^{2} + {d}^{2} - {R}_{1}^{2}}{2 xd} )$$

is the largest value of □SUU′ that satisfies R₂<R₁. The probability that any node moves into the transmission range of node S at t₁ is

$$p ( x ) = {\int }_{{R}_{t}}^{∞} p ( x , d ) d d \qquad ( 17 )$$

The probability that a node with any relative speed v with respect to S moves into its transmission range is

$$p = {\int }_{0}^{2 s} {f}_{\vert \vec{V} \vert} ( v ) p ( fv ) d v \qquad ( 18 )$$

where \vec{V} is the random relative velocity vector proposed in previous section and s is the maximum speed for any node. Recall, the direction of \vec{V} is also uniformly distributed in [0, 2π] and is independent of the speed of \vec{V}. We know that □\vec{V}□ is uniformly distributed in [0, 2π]. We calculate f_{□}\vec{V}_{□} at a give time t as

$$\begin{matrix}{f}_{\vert \vec{V} \vert} ( t ) \approx \frac{{F}_{\vert \vec{V} \vert} ( {δ}_{t} ) - {F}_{\vert \vec{V} \vert} ( t )}{{δ}_{t}} \\ = \frac{P ( t \leq \vert \vec{V} \vert \leq t + {δ}_{t} )}{{δ}_{t}} \\ = {∮}_{( 0 , 0 )}^{( 2 π , s )} {∮}_{( 0 , 0 )}^{( 2 π , s )} \frac{R ( {\vec{V}}_{2} , {\vec{V}}_{1} , t , t + {δ}_{t} )}{{( 2 π s )}^{2} {δ}_{t}} \cdot d {\vec{V}}_{2} d {\vec{V}}_{1} ,\end{matrix} \qquad ( 19 )$$

where f_{□}\vec{V}_{□(t)} is the distribution function, δₜ is a small positive value, and

$$R ( {\vec{V}}_{2} , {\vec{V}}_{1} , a , b ) = \{ \begin{matrix}1 \text{:} & a \leq \vert {\vec{V}}_{2} - {\vec{V}}_{1} \vert \leq b \\ 0 \text{:} & otherwise .\end{matrix} \qquad ( 20 )$$

Combining all above formulas, we can calculate the probability that any node U moves into the transmission range of node S. Then, the expected value of smaller neighborhood range (SR) can be given by

E[SR]=(1−p)R₁ (21)

### 5. Simulation Results

We use ns-2.28 and its CMU wireless extension as simulation tool and assume AT&T's Wave LAN PCMCIA card as wireless node model with parameters as listed in Table 1. To demonstrate the comprehensive effectiveness of our proposal, we perform experiments in not only linear (Random Waypoint) but also nonlinear (Gauss-Markov) mobility models which are widely used in simulating protocols designed for MANETs.

In neighborhood tracking, any node S is randomly chosen to predict its neighbor nodes' locations for constructing local view. Local view construction occurs within update interval. Table 2 displays our simulation parameters.

TABLE 1
Parameters for wireless node model

| Parameters | Value |
|---|---|
| Frequency | 2.4 GHz |
| Maximum transmission range | 250 m |
| MAC protocol | 802.11 |
| Propagation model | free space/two ray ground |

TABLE 2
Simulation parameters

| Parameters | Value |
|---|---|
| Simulation network size | 900 × 900 m² |
| Mobile nodes speed range | [0, 15] m/s |
| Nodes number | 50 |
| Simulation time | 50 s |
| Periodical update/check interval | 2 s |
| Prediction interval | 20 ms |
| Reference distance of conditional update | 1 m |

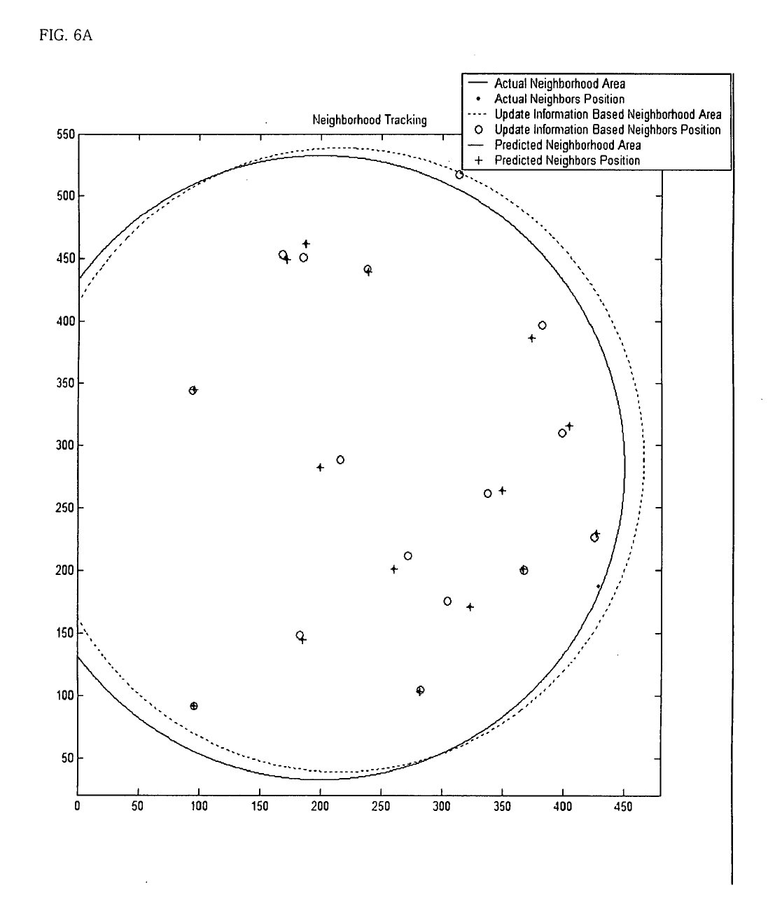

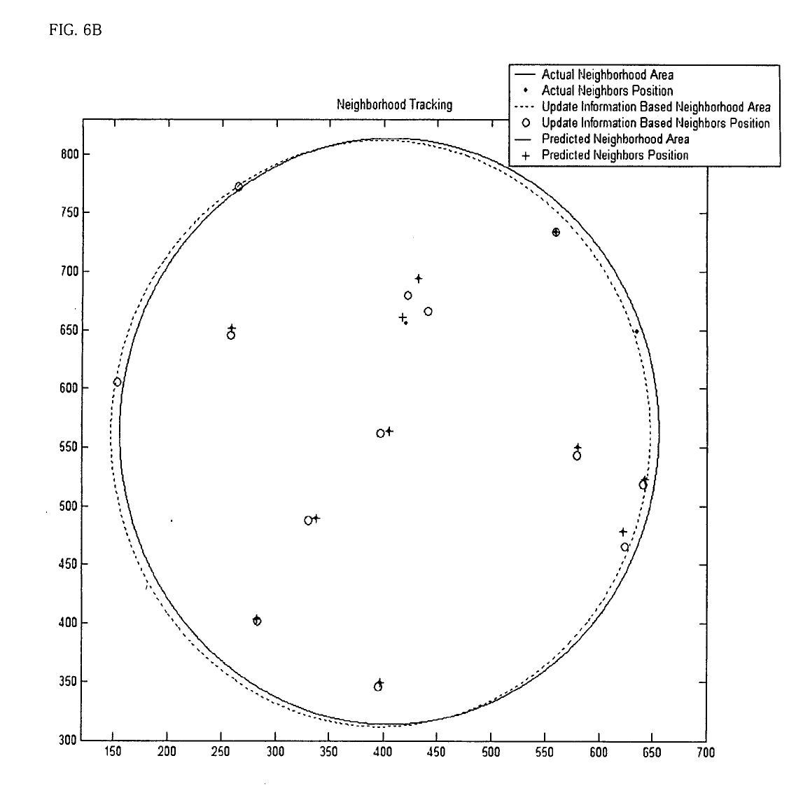

The sample of predicted local view with velocity-based prediction under periodical update is illustrated in FIG. 6 where the actual local view and local view based on update information are also shown for comparison. We can find that whatever in linear model or nonlinear mobile environment our predictive neighborhood views are almost the same as actual neighborhoods while update info based views show obvious inaccuracy.

To evaluate the inaccuracy of local view, we define the metric of position error (PE) as the average distance difference between neighbors' actual positions and their positions in neighborhood view. For any node S suppose there are K neighbors (including S itself) in its jth local view, and for any neighbor i let (xᵢ, yᵢ, zᵢ) represent the actual location and (x′ᵢ, y′ᵢ, z′ᵢ) be the location in local view, the PEⱼ for the jth neighborhood can be calculated as

$$\sqrt{\frac{1}{K} {\sum }_{i = 1}^{K} [ {( {x}_{i}^{′} - {x}_{i} )}^{2} + {( {y}_{i}^{′} - {y}_{i} )}^{2} + {( {z}_{i}^{′} - {z}_{i} )}^{2} ]} \qquad ( 22 )$$

Finally suppose we have W local views,

$$PE = \frac{1}{W} {\sum }_{j = 1}^{W} {PE}_{j} \qquad ( 23 )$$

The smaller the value of PE is, the more accurate the neighborhood local view is.

Table 3 and 4 show position error results under Random Waypoint and Gauss-Markov models in our simulation. From above simulation results we can demonstrate (1) both periodical and conditional update info based view has more than three times inaccuracy compared with that of our tracking schemes, which proves the necessary and effectiveness of our proposition, (2) our schemes have very small prediction inaccuracy (especially in linear mobility environment), that is, they can precisely track neighborhood, (3) but different prediction models have different performance: velocity-aided scheme performs much better than other two methods and the constant acceleration model does better than location-based one, (4) in addition, the mobility model and update protocol also affects the performance of our scheme: under different mobility models and update protocols the PE values are also different.

TABLE 3
PE under Random Waypoint model

| Records Type | Prediction Scheme | PE Value |
|---|---|---|
| Periodical | Update Info Based | 7.258410 |
| Update | Location-based | 0.755039 |
| | Velocity-aided | 0.003444 |
| | Constant Acceleration | 0.261483 |
| Conditional | Update Info Based | 9.267584 |
| Update | Velocity-aided | 0.000006 |
| | Constant Acceleration | 0.637606 |

TABLE 4
PE under Gauss-Markov Model

| Records Type | Prediction Scheme | PE Value |
|---|---|---|
| Periodical | Update Info Based | 7.407275 |
| Update | Location-based | 2.281239 |
| | Velocity-aided | 0.497334 |
| | Constant Acceleration | 1.046533 |
| Conditional | Update Info Based | 9.497269 |
| Update | Velocity-aided | 1.617758 |
| | Constant Acceleration | 2.813394 |

What has been described are preferred embodiments of the present invention. The foregoing description is intended to be exemplary and not limiting in nature. Persons skilled in the art will appreciate that various modifications and additions may be made while retaining the novel and advantageous characteristics of the invention and without departing from this spirit. Accordingly, the scope of the invention is defined solely by the appended claims as properly interpreted.

What is claimed is:

1. Method for predicting the mobility in mobile ad hoc networks, the method comprising steps of:
constructing neighborhood local view of a node;
predicting locations of said node and its neighbor nodes at the same future time using said neighborhood local view in prescribed time interval;
updating neighborhood local view by aggregating neighbors' predicted location;
reconstructing said neighborhood local view by setting smaller neighborhood range.

2. The method as claimed in claim 1, wherein the prescribed time interval is time period within which any neighbor node stays in the transmission range of said node, T_{dwell} is given by
$$E [ {T}_{dwell} ] = \frac{π A}{E [ V ] L}$$
where E[T_{dwell}] is average value of the T_{dwell}, A is the area of the transmission range, L is the perimeter of this area, E[V] is average value of V and V is relative velocity vector of node.

3. The method as claimed in claim 2, wherein average value of V, E[V] is given by
$$E [ V ] = \frac{1}{{π}^{2}} {\int }_{{V}_{min}}^{{V}_{max}} {\int }_{{V}_{min}}^{{V}_{max}} ( {v}_{1} + {v}_{2} ) {F}_{e} ( \frac{2 \sqrt{{v}_{1} {v}_{2}}}{{v}_{1} + {v}_{2}} ) {f}_{V} ( {v}_{1} ) {f}_{V} ( {v}_{2} ) d {v}_{1} d {v}_{2}$$
where
$${F}_{e} ( k ) = {\int }_{0}^{1} \sqrt{\frac{1 - {k}^{2} {t}^{2}}{1 - {t}^{2}}} d t$$
is complete elliptic integral of the second kind, fv(v1), fv(v2) is the joint pdf of the random variables V1, V2.

4. The method as claimed in claim 1, wherein in said step of predicting locations of said node and its neighbor nodes, each location (xₚ, yₚ, zₚ) at a future time tₚ is calculated as
$$\{ \begin{matrix}{x}_{p} = {x}_{1 h} + \frac{{x}_{1 h} - {x}_{2 h}}{{t}_{1 h} - {t}_{2 h}} ( {t}_{p} - {t}_{1 h} ) \\ {y}_{p} = {y}_{1 h} + \frac{{y}_{1 h} - {y}_{2 h}}{{t}_{1 h} - {t}_{2 h}} ( {t}_{p} - {t}_{1 h} ) \\ {z}_{p} = {z}_{1 h} + \frac{{z}_{1 h} - {z}_{2 h}}{{t}_{1 h} - {t}_{2 h}} ( {t}_{p} - {t}_{1 h} )\end{matrix}$$
where (x₁ₕ, y₁ₕ, z₁ₕ) is a location at a time t₁ₕ, (x₂ₕ, y₂ₕ, z₂ₕ) is a location at a time t₂ₕ, and t₁ₕ>t₂ₕ.

5. The method as claimed in claim 1, wherein in said step of predicting locations of said node and its neighbor nodes, each location (xₚ, yₚ, zₚ) at a future time tₚ is calculated as
$$\{ \begin{matrix}{x}_{p} = {x}_{1 h} + {v}_{x}^{′} ( {t}_{p} - {t}_{1 h} ) \\ {y}_{p} = {y}_{1 h} + {v}_{y}^{′} ( {t}_{p} - {t}_{1 h} ) \\ {z}_{p} = {z}_{1 h} + {v}_{z}^{′} ( {t}_{p} - {t}_{1 h} )\end{matrix}$$
where (x₁ₕ, y₁ₕ, z₁ₕ) is a location at a time t₁ₕ, (v′ₓ, v′_{y}, v′_{z}) is a velocity of latest update for a particular node.

6. The method as claimed in claim 1, wherein in said step of predicting locations of said node and its neighbor nodes, each location (xₚ, yₚ, zₚ) at a future time tₚ is calculated as
$$\{ \begin{matrix}{x}_{p} = {x}_{1 h} + \frac{2 {v}_{x}^{′} + ( {v}_{x}^{′} - {v}_{x}^{″} ) \frac{{t}_{p} - {t}_{1 h}}{{t}_{1 h} - {t}_{2 h}}}{2} ( {t}_{p} - {t}_{1 h} ) \\ {y}_{p} = {y}_{1 h} + \frac{2 {v}_{y}^{′} + ( {v}_{y}^{′} - {v}_{y}^{″} ) \frac{{t}_{p} - {t}_{1 h}}{{t}_{1 h} - {t}_{2 h}}}{2} ( {t}_{p} - {t}_{1 h} ) \\ {z}_{p} = {z}_{1 h} + \frac{2 {v}_{z}^{′} + ( {v}_{z}^{′} - {v}_{z}^{″} ) \frac{{t}_{p} - {t}_{1 h}}{{t}_{1 h} - {t}_{2 h}}}{2} ( {t}_{p} - {t}_{1 h} )\end{matrix}$$
where (x₁ₕ, y₁ₕ, z₁ₕ) is a location at a time t₁ₕ, (v′ₓ, v′_{y}, v′_{z}) is the velocity of first update for a particular node, and (v−ₓ, v″_{y}, v″_{z}) is the velocity of second update for a particular node.

7. The method as claimed in claim 1, wherein said smaller neighborhood range SR is given by
E[SR]=(1−p)R₁
where p is probability that any node moves into the transmission range of node S, R₁ is radius of node S.

8. The method as claimed in claim 7, wherein
$$R ( {\vec{V}}_{2} , {\vec{V}}_{1} , a , b ) = \{ \begin{matrix}1 \text{:} & a \leq \vert {\vec{V}}_{2} - {\vec{V}}_{1} \vert \leq b \\ 0 \text{:} & otherwise .\end{matrix}$$
where v is a relative speed, \vec{V} is the random relative velocity vector proposed in previous section and s is the maximum speed for any node.

9. The method as claimed in claim 8, wherein
$$\begin{matrix}{f}_{\vert \vec{V} \vert} ( t ) \approx \frac{{F}_{\vert \vec{V} \vert} ( {δ}_{t} ) - {F}_{\vert \vec{V} \vert} ( t )}{{δ}_{t}} \\ = \frac{P ( t \leq \vert \vec{V} \vert \leq t + {δ}_{t} )}{{δ}_{t}} \\ = {∮}_{( 0 , 0 )}^{( 2 π , s )} {∮}_{( 0 , 0 )}^{( 2 π , s )} \frac{R ( {\vec{V}}_{2} , {\vec{V}}_{1} , t , t + {δ}_{t} )}{{( 2 π s )}^{2} {δ}_{t}} \cdot d {\vec{V}}_{2} d {\vec{V}}_{1} ,\end{matrix}$$
where f_{□}\vec{V}_{□(t)} is the distribution function, δₜ is a small positive value, and
$$p = {\int }_{0}^{2 s} {f}_{\vert \vec{V} \vert} ( v ) p ( fv ) d v$$
